(19) United States
(12) Patent Application Publication
(10) Pub. No.: US 2003/0072599 A1
(43) Pub. Date: Apr. 17, 2003

(54) Apparatus using gel ink

(76) Inventor: Sheri Lynne Ewart, Prince George (CA)

Correspondence Address: Clark, Wilson, Attn: Michael J. Roman, Suite 800, 885 West Georgia Street, Vancouver, BC, V6C 3H1, CA

(21) Appl. No.: 10/268,780

(22) Filed: Oct. 11, 2002

Related U.S. Application Data
(60) Provisional application No. 60/328,204, filed on Oct. 11, 2001.

(51) Int. Cl. B43K 8/08; B43K 5/00; A47L 1/08

(52) U.S. Cl. 401/199; 401/198; 401/23

(57) ABSTRACT

Apparatuses using gel ink to create images, particularly, generally pen shaped stampers and markers, wherein gel ink of various types are used. The gel ink travels from an ink tip through an ink conduit to saturate the applicator. The ink tip forms the top end of the ink conduit and the applicator forms the bottom end of the ink conduit. All three components are made of a porous material that will absorb the gel ink. The apparatus using gel ink for creating images can then be used to stamp or to draw on a surface.

This application claims priority from U.S. Provisional Application Serial No. 60/328,204 filed on Oct. 11, 2001 by Sheri Lynne Ewart and Sheila Anne Kennedy, and the entire disclosure of such provisional application is expressly incorporated herein by reference.

A portion of the disclosure of this patent document contains material which is subject to copyright protection. The copyright owner has no objection to the facsimile reproduction of the patent document or the patent disclosure as it appears in the public Patent Office file or records but otherwise reserves all rights.

### TECHNICAL FIELD

This invention relates to apparatuses using gel ink for creating images, particularly, generally pen shaped stampers and markers.

### BACKGROUND

There are various conventional ink stamps available on the market for home and office purposes. Such conventional ink stamps include rubber stamps mounted on blocks that are dipped into ink pads before use and self-inking stamps, which are mounted rubber stamps with a built-in ink pad. Ink stamps that require a separate ink pad are inconvenient and messy to use. Stamps with a built-in ink pad, although convenient, typically use ink with undesirable qualities. The ink used for most stamps is pigment based, dye based, or water based. Pigment based inks are very difficult to remove and stain skin and furniture. Dye based inks have a tendency to soak through paper. Water based inks take a long time to dry, increasing the likelihood of smudging and “bleeding” of the ink. These unfavourable qualities of typical stamp inks are even more problematic when they are used by children for arts and crafts.

Most markers on the market use either solvent based or water based inks. Solvent based inks are permanent and cannot be washed off with water. Solvent based inks usually soak through paper and are difficult to remove, and some solvent based inks are even toxic. Water based inks are generally water soluble and non-toxic but not all water based inks are necessarily washable. As with water based inks for stamping, the longer drying time of such inks increases the chance of smudging and “bleeding” of the ink.

It is an object of the invention to provide an apparatus for creating images, such as a stamper or a marker, that uses gel ink, which is a non-toxic washable ink that will not soak through paper or smudge.

### SUMMARY OF THE INVENTION

The present invention is an apparatus using gel ink for creating images, particularly, a generally pen shaped stamper and a marker, comprising a receptacle containing gel ink, a hollow casing to contain the receptacle, and an applicator. The apparatus has top and bottom ends with the applicator at the bottom end. The applicator, which is formed at the bottom end of an ink conduit, is saturated with gel ink through an ink tip, which is formed at the top end of the ink conduit. The applicator, ink conduit, and ink tip are made of a porous material, such as foam or felt. The ink tip is inserted in the receptacle containing gel ink and receives gel ink from the receptacle to saturate the applicator. Alternatively, the top end of the apparatus may also have a second applicator.

### BRIEF DESCRIPTION OF FIGURES

Further objects, features and advantages of the present invention will become more readily apparent to those skilled in the art from the following description of the invention when taken in conjunction with the accompanying drawings, in which:

FIG. 1 is a cross sectional view of a stamper according to an embodiment of the invention;

FIG. 2 is a cross section of the ink conduit therein;

FIG. 3 is a cross sectional view of a marker according to an embodiment of the invention;

FIG. 4 is a cross sectional view of an alternative embodiment of a stamper according to the invention; and

FIG. 5 is a cross sectional view of an alternative embodiment of a marker according to the invention.

### DETAILED DESCRIPTION OF PREFERRED EMBODIMENTS

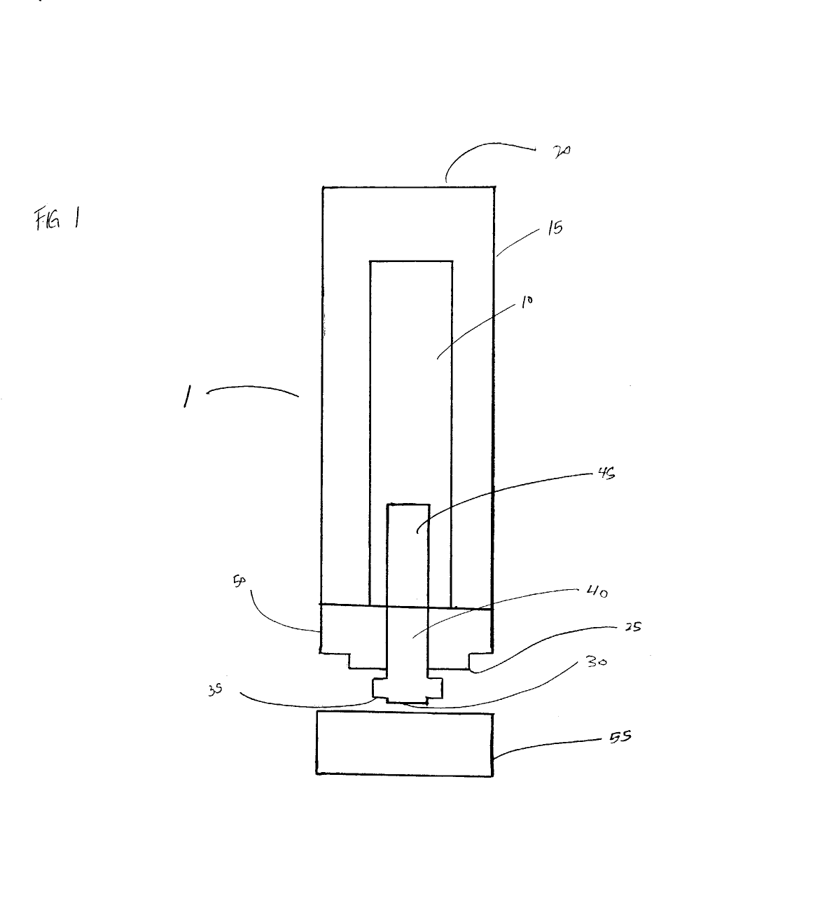

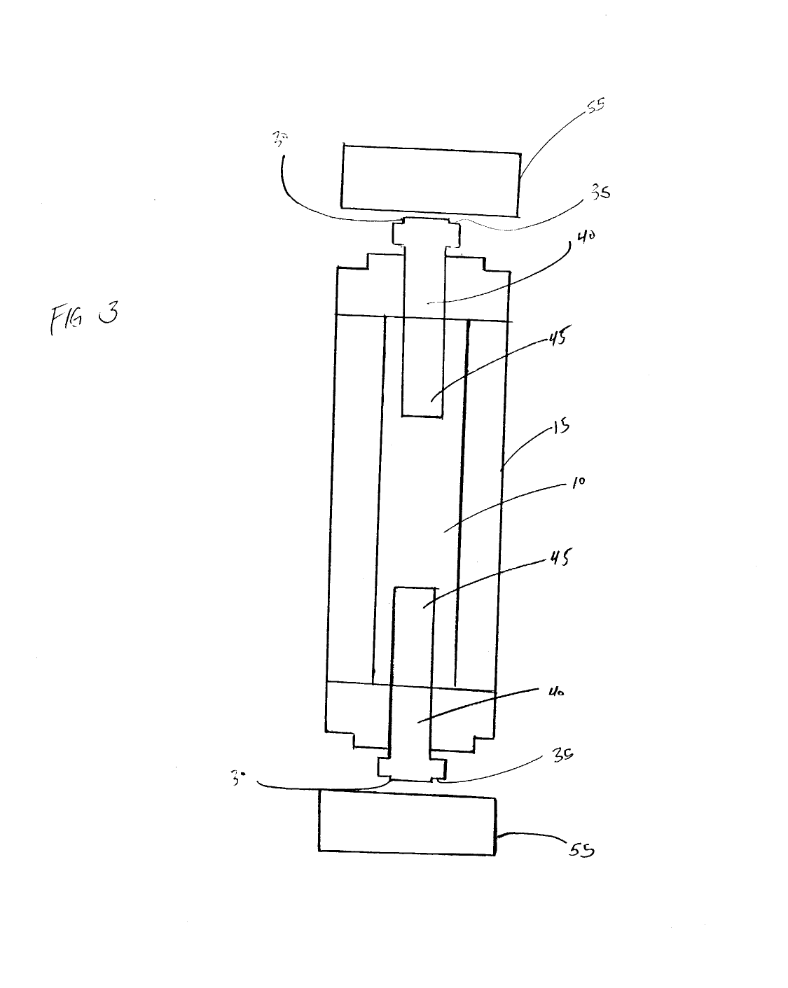

The following detailed description will be made with reference to two preferred embodiments of an apparatus using gel ink of various types for creating images, particularly, a pen shaped stamper (as seen in FIG. 1) and a marker (as seen in FIG. 3). In this document, the term “applicator” is the means by which the apparatus creates an image on a surface, and includes a stamp die and a marker tip.

Gel ink is a fusion of water and oil based ink or soap based ink that will not fade or bleed and is washable. Gel ink accepts a higher saturation of pigment than most other inks, making gel ink colours more vivid. There are many types of gel inks, including metallic ink, glitter ink, and pastel ink. The embodiments of the apparatuses using gel ink disclosed herein can be used with any type of gel ink.

As illustrated in FIG. 1, one embodiment of the apparatus using gel ink is a stamper. The gel ink for stamper 1 is contained within receptacle 10. Receptacle 10 can be made of any material, such as steel, but is preferably plastic. Receptacle 10 can be of any shape, including tube shaped or box shaped. Receptacle 10 is typically tube shaped, measuring approximately 5½″ in length and ⅕″ in diameter.

Receptacle 10 is positioned within first hollow casing 15. First hollow casing 15 can be made of any material including rubber or steel, but is typically plastic. First hollow casing 15 can be of any shape, such as pen shaped or rectangular shaped. Typically, first hollow casing 15 is pen shaped and measures approximately 5¾″ in length and ½″ in diameter.

In an alternative embodiment of stamper 1, receptacle 10 may be removed from first hollow casing 15 and replaced with another receptacle 10 containing the same or different type or colour of gel ink. Such an embodiment allows stamper 1 to be refilled with gel ink and therefore have a longer useable life.

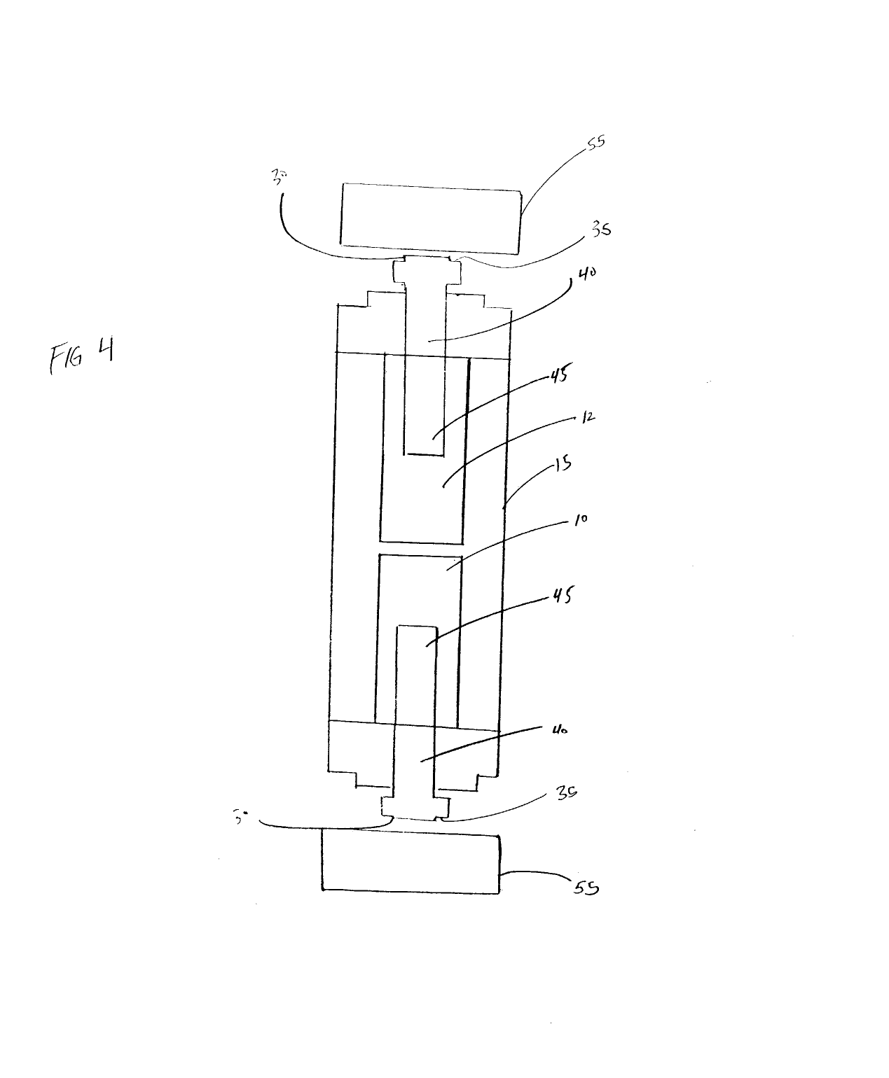

Stamper 1 has top and bottom ends 20, 25. As illustrated in FIG. 1, one embodiment of stamper 1 includes a stamp die 30 on bottom end 25 and top end 20 is enclosed by first hollow casing 15. Alternatively, top and bottom ends 20, 25 of stamper 1 each may have a stamp die 30 as illustrated in FIG. 4. Stamp die 30 extends slightly from stamp face 35 to create a representation on stamp face 35. Examples of such representations include cartoon characters, flowers, words, and design images. Stamp die 30 contacts the object to be stamped. The preferred size of stamp face 35 is ½″ in diameter. Stamp die 30 must conform to the size of stamp face 35. Stamp die 30 and stamp face 35 are typically made of a porous material that will absorb the gel ink such as foam or felt.

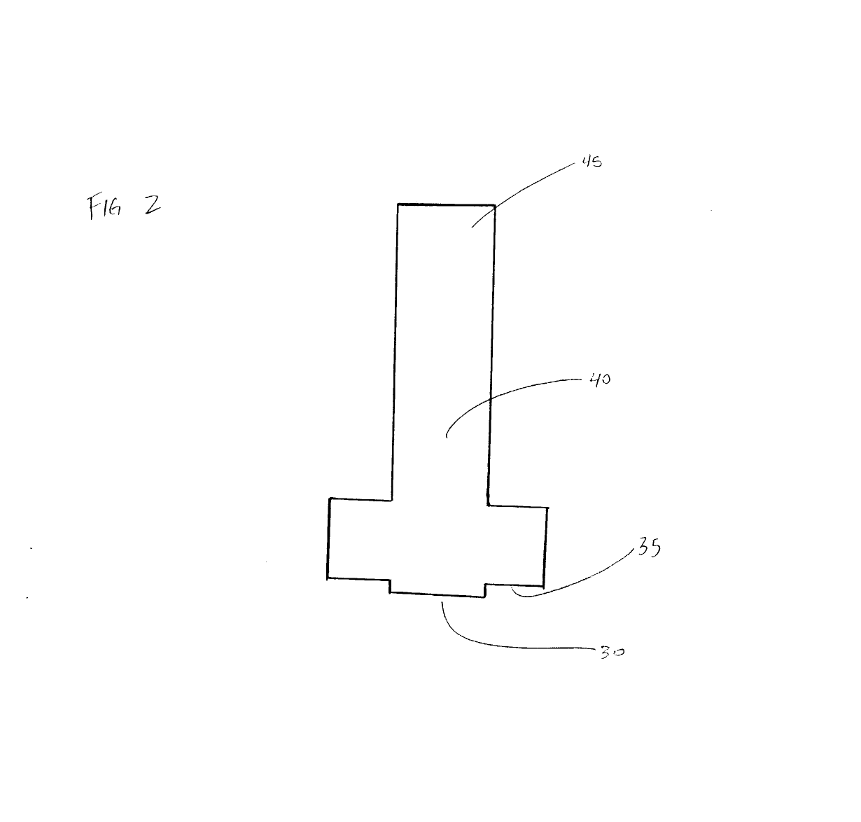

As illustrated in FIG. 2, ink conduit 40 has a top and bottom end. On the bottom end of ink conduit 40 is stamp die 30 extending slightly from stamp face 35. On the top end of ink conduit 40 is ink tip 45. Ink conduit 40, ink tip 45, stamp die 30, and stamp face 35 are all made of the same porous material such as foam or felt. Ink tip 45 is positioned in receptacle 10 and receives and absorbs the gel ink therefrom. The gel ink absorbed through ink tip 45 supplies the gel ink to stamp die 30 through ink conduit 40.

Ink conduit 40 is contained within second hollow casing 50 which is attached to first hollow casing 15. Second hollow casing 50 can be made of any material and typically matches the material of first hollow casing 15. Second hollow casing 50 can be permanently attached to first hollow casing 15 or can be detachable. Typically, second hollow casing 50 is detachable to allow for replacement of a new receptacle 10 when the gel ink dries out. In addition, second hollow casing 50 is detachable to allow for different stamp dies 30 to be used with stamper 1. This enables stamper 1 to be used to imprint a multitude of representations.

To protect stamp die 30 and the gel ink from drying out, a detachable cap 55 may be attached to second hollow casing 50. If both top and bottom ends 20, 25 of stamper 1 have a stamp die 30, then a second detachable cap for the second stamp die is preferred. Detachable cap 55 can be made of any material but it preferably matches the material of first hollow casings 15 and 50.

As illustrated in FIG. 4, another embodiment of stamper 1 includes a second receptacle 12 positioned within first hollow casing 15 that may contain a different type or colour of gel ink for the second stamp die 30 on top end 20. If there are two receptacles 10, 12 positioned within first hollow casing 15, each receptacle should measure approximately 2¼″ in length.

Stamper 1 is used by applying stamp die 30 to an object and pressing down to imprint the representation on the object. By pressing stamper 1 down, the gel ink is released through the porous material of ink tip 45 to saturate the porous material of stamp die 30.

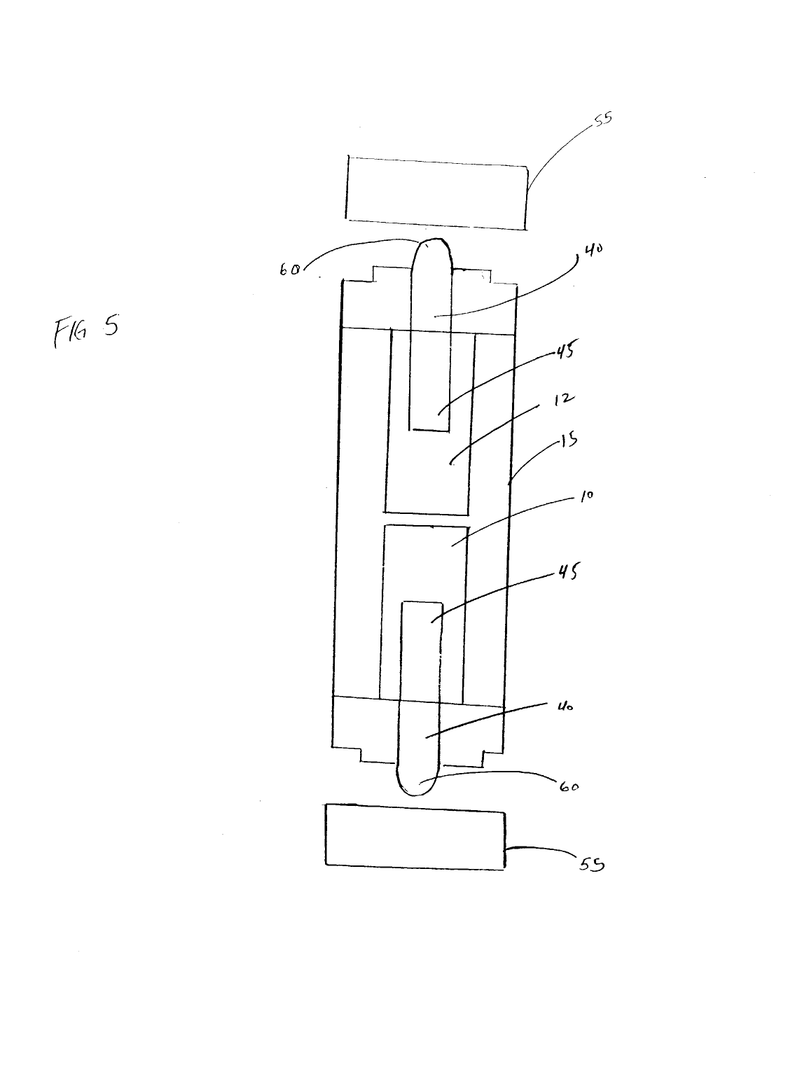

As illustrated in FIG. 3, another preferred embodiment of the apparatus using gel ink is a marker. The description of the embodiment of marker 3 is substantially the same as stamper 1 as disclosed above, except marker 2 has a marker tip 60 on bottom end 25 instead of a stamp die 30. Marker tip 60 varies in size and type. Examples of such different marker tips 60 known in the art include fine tips, broad tips, chisel tips, medium tips, and double ended tips. Alternatively, top and bottom ends 20, 25 of marker 3 each can have a marker tip 60 as illustrated in FIG. 5.

While the principles of the invention have now been made clear in the illustrated embodiments, it will be immediately obvious to those skilled in the art that many modifications may be made of structure, arrangements, and algorithms used in the practice of the invention, and otherwise, which are particularly adapted for specific environments and operational requirements, without departing from those principles. The claims are therefore intended to cover and embrace such modifications within the limits only of the true spirit and scope of the invention.

What is claimed is:

1. An apparatus using gel ink, comprising:
(a) a first hollow casing having a first and a second end;
(b) a receptacle adapted to contain gel ink positioned within said first hollow casing;
(c) said first end comprising:
(i) an ink conduit having a top and bottom end;
(ii) an ink tip on said top end inserted in said receptacle;
(iii) an applicator on said bottom end; and
(iv) a second hollow casing containing said ink conduit; and
(c) at least one cap attachable to said second hollow casing.

2. The apparatus for using gel ink of claim 1 wherein said receptacle is tube shaped, measuring generally 5½″ in length and ⅕″ in diameter.

3. The apparatus for using gel ink of claim 2 wherein said first hollow casing is tube shaped, measuring generally 5¾″ in length and ½″ in diameter

4. The apparatus for using gel ink of claim 3 wherein said ink conduit is foam or felt.

5. The apparatus for using gel ink of claim 4 wherein said receptacle is replaceable.

6. The apparatus for using gel ink of claim 5 wherein said ink conduit is replaceable.

7. The apparatus for using gel ink of claim 1, wherein said second end comprises:
(a) a second ink conduit having a top and bottom end;
(b) a second ink tip on said top end inserted in a second receptacle;
(c) a second applicator on said bottom end; and
(d) a third hollow casing containing said second ink conduit.

8. The apparatus for using gel ink of claim 7, wherein a second cap is attachable to said third hollow casing.

9. The apparatus for using gel ink of claim 8 wherein said second ink tip is inserted into said second receptacle containing gel ink positioned within said first hollow casing.

10. The apparatus for using gel ink of claim 9 wherein said receptacle and said second receptacle are tube-shaped, measure generally 2¼″ in length and ⅕″ in diameter.

11. The apparatus for using gel ink of claim 10 wherein said receptacle and said second receptacle are replaceable.

12. The apparatus for using gel ink of claim 11 wherein said second ink conduit is foam or felt.

13. The apparatus for using gel ink of claim 12 wherein said second ink conduit is replaceable.
